(19) United States
(12) Patent Application Publication
(10) Pub. No.: US 2021/0357625 A1
(43) Pub. Date: Nov. 18, 2021

(54) METHOD AND DEVICE FOR GENERATING VIDEO, ELECTRONIC EQUIPMENT, AND COMPUTER STORAGE MEDIUM

(71) Applicant: BEIJING SENSETIME TECHNOLOGY DEVELOPMENT CO., LTD., Beijing (CN)

(72) Inventors: Linsen SONG, Beijing (CN); Wenyan WU, Beijing (CN); Chen QIAN, Beijing (CN); Ran HE, Beijing (CN)

(21) Appl. No.: 17/388,112

(22) Filed: Jul. 29, 2021

Related U.S. Application Data
(63) Continuation of application No. PCT/CN2020/114103, filed on Sep. 8, 2020.

(30) Foreign Application Priority Data
Sep. 18, 2019 (CN) 201910883605.2

(51) Int. Cl. G06K 9/00; G06N 3/04; G06T 5/00; G06F 16/783

(52) U.S. Cl. CPC G06K 9/00248; G06K 9/00315; G06N 3/04; G06T 5/005; G06T 5/002; G06F 16/7834; G06T 5/004

(57) ABSTRACT

Face shape information and head posture information are extracted from each face image. Facial expression information is acquired according to an audio clip corresponding to the each face image. Face key point information of the each face image is acquired according to the facial expression information, the face shape information, and the head posture information. Face images acquired are inpainted according to the face key point information, acquiring each generated image. A target video is generated according to the each generated image.

### CROSS-REFERENCE TO RELATED APPLICATIONS

This application is a continuation of International Application No. PCT/CN2020/114103, filed on Sep. 8, 2020, which per se is based on, and claims benefit of priority to, Chinese Application No. 201910883605.2, filed on Sep. 18, 2019. The disclosures of International Application No. PCT/CN2020/114103 and Chinese Application No. 201910883605.2 are hereby incorporated by reference in their entireties.

### TECHNICAL FIELD

The subject disclosure relates to the field of image processing, and more particularly, to a method and device for generating a video, electronic equipment, a computer storage medium, and a computer program.

### BACKGROUND

In related art, talking face generation is an important direction of research in a voice-driven character and a video generation task. However, a relevant scheme for generating a talking face fails to meet an actual need for association with a head posture.

### SUMMARY

Embodiments of the present disclosure are to provide a method for generating a video, electronic equipment, and a storage medium.

A technical solution herein is implemented as follows.

Embodiments of the present disclosure provide a method for generating a video. The method includes:

acquiring face images and an audio clip corresponding to each face image of the face images;

extracting face shape information and head posture information from the each face image, acquiring facial expression information according to the audio clip corresponding to the each face image, and acquiring face key point information of the each face image according to the facial expression information, the face shape information, and the head posture information;

inpainting, according to the face key point information of the each face image, the face images acquired, acquiring each generated image; and

generating a target video according to the each generated image.

Embodiments of the present disclosure also provide a device for generating a video. The device includes a first processing module, a second processing module, and a generating module.

The first processing module is configured to acquire face images and an audio clip corresponding to each face image of the face images.

The second processing module is configured to extract face shape information and head posture information from the each face image, acquire facial expression information according to the audio clip corresponding to the each face image, and acquire face key point information of the each face image according to the facial expression information, the face shape information, and the head posture information; inpaint, according to the face key point information of the each face image, the face images acquired, acquiring each generated image.

The generating module is configured to generate a target video according to the each generated image.

Embodiments of the present disclosure also provide electronic equipment, including a processor and a memory configured to store a computer program executable on the processor.

The processor is configured to implement any one method for generating a video herein when executing the computer program.

Embodiments of the present disclosure also provide a non-transitory computer-readable storage medium, having stored thereon a computer program which, when executed by a processor, implements any one method for generating a video herein.

In a method and device for generating a video, electronic equipment, and a computer storage medium provided by embodiments of the present disclosure, face images and an audio clip corresponding to each face image of the face images are acquired; face shape information and head posture information are extracted from the each face image; facial expression information is acquired according to the audio clip corresponding to the each face image; face key point information of the each face image is acquired according to the facial expression information, the face shape information, and the head posture information; the face images acquired are inpainted according to the face key point information of the each face image, acquiring each generated image; and a target video is generated according to the each generated image. In this way, in embodiments of the present disclosure, since the face key point information is acquired by considering the head posture information, each generated image acquired according to the face key point information may reflect the head posture information, and thus the target video may reflect the head posture information. The head posture information is acquired according to each face image, and each face image may be acquired according to a practical need related to a head posture. Therefore, with embodiments of the present disclosure, a target video may be generated corresponding to each face image that meets the practical need related to the head posture, so that the generated target video meets the practical need related to the head posture.

It should be understood that the general description above and the detailed description below are illustrative and explanatory only, and do not limit the present disclosure.

### BRIEF DESCRIPTION OF THE ACCOMPANYING DRAWINGS

Drawings here are incorporated in and constitute part of the specification, illustrate embodiments according to the present disclosure, and together with the specification, serve to explain the principle of the present disclosure.

FIG. 1 is a flowchart of a method for generating a video according to embodiments of the present disclosure.

FIG. 2 is an illustrative diagram of architecture of a first neural network according to embodiments of the present disclosure.

FIG. 3 is an illustrative diagram of acquiring face key point information of each face image according to embodiments of the present disclosure.

FIG. 4 is an illustrative diagram of architecture of a second neural network according to embodiments of the present disclosure.

FIG. 5 is a flowchart of a method for training a first neural network according to embodiments of the present disclosure.

FIG. 6 is a flowchart of a method for training a second neural network according to embodiments of the present disclosure.

FIG. 7 is an illustrative diagram of a structure of a device for generating a video according to embodiments of the present disclosure.

FIG. 8 is an illustrative diagram of a structure of electronic equipment according to embodiments of the present disclosure.

### DETAILED DESCRIPTION

The present disclosure is further elaborated below with reference to the drawings and embodiments. It should be understood that an embodiment provided herein is intended but to explain the present disclosure instead of limiting the present disclosure. In addition, embodiments provided below are part of the embodiments for implementing the present disclosure, rather than providing all the embodiments for implementing the present disclosure. Technical solutions recorded in embodiments of the present disclosure may be implemented by being combined in any manner as long as no conflict results from the combination.

It should be noted that in embodiments of the present disclosure, a term such as “including/comprising”, “containing”, or any other variant thereof is intended to cover a non-exclusive inclusion, such that a method or a device including a series of elements not only includes the elements explicitly listed, but also includes other element(s) not explicitly listed, or element(s) inherent to implementing the method or the device. Given no more limitation, an element defined by a phrase “including a . . . ” does not exclude existence of another relevant element (such as a step in a method or a unit in a device, where for example, the unit may be part of a circuit, part of a processor, part of a program or software, etc.) in the method or the device that includes the element.

For example, the method for generating a video provided by embodiments of the present disclosure includes a series of steps. However, the method for generating a video provided by embodiments of the present disclosure is not limited to the recorded steps. Likewise, the device for generating a video provided by embodiments of the present disclosure includes a series of modules. However, devices provided by embodiments of the present disclosure are not limited to include the explicitly recorded modules, and may also include a module required, acquiring relevant information or perform processing according to information.

A term “and/or” herein merely describes an association between associated objects, indicating three possible relationships. For example, by A and/or B, it may mean that there may be three cases, namely, existence of but A, existence of both A and B, or existence of but B. In addition, a term “at least one” herein means any one of multiple, or any combination of at least two of the multiple. For example, including at least one of A, B, and C may mean including any one or more elements selected from a set composed of A, B, and C.

Embodiments of the present disclosure may be applied to a computer system composed of a terminal and/or a server, and may be operated with many other general-purpose or special-purpose computing system environments or configurations. Here, a terminal may be a thin client, a thick client, handheld or laptop equipment, a microprocessor-based system, a set-top box, a programmable consumer electronic product, a network personal computer, a small computer system, etc. A server may be a server computer system, a small computer system, a large computer system and distributed cloud computing technology environment including any of above-mentioned systems, etc.

Electronic equipment such as a terminal, a server, etc., may be described in the general context of computer system executable instructions (such as a program module) executed by a computer system. Generally, program modules may include a routine, a program, an object program, a component, a logic, a data structure, etc., which perform a specific task or implement a specific abstract data type. A computer system/server may be implemented in a distributed cloud computing environment. In a distributed cloud computing environment, a task is executed by remote processing equipment linked through a communication network. In a distributed cloud computing environment, a program module may be located on a storage medium of a local or remote computing system including storage equipment.

In some embodiments of the present disclosure, a method for generating a video is proposed. Embodiments of the present disclosure may be applied to a field such as artificial intelligence, Internet, image and video recognition, etc. Illustratively, embodiments of the present disclosure may be implemented in an application such as man-machine interaction, virtual conversation, virtual customer service, etc.

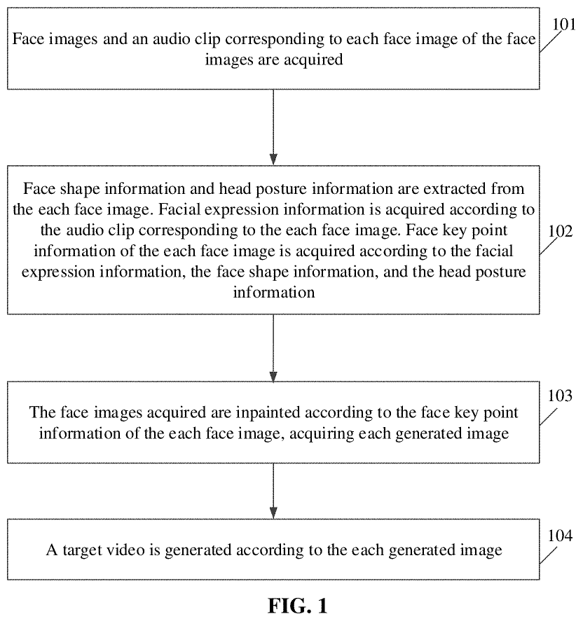

FIG. 1 is a flowchart of a method for generating a video according to embodiments of the present disclosure. As shown in FIG. 1, the flow may include steps as follows.

In S101, face images and an audio clip corresponding to each face image of the face images are acquired.

In a practical application, source video data may be acquired. The face images and audio data including a voice may be separated from the source video data. The audio clip corresponding to the each face image may be determined. The audio clip corresponding to the each face image may be part of the audio data.

Here, each image of the source video data may include a face image. The audio data in the source video data may include the voice of a speaker. In embodiments of the present disclosure, a source and a format of the source video data are not limited.

In embodiments of the present disclosure, a time period of an audio clip corresponding to a face image includes a time point of the face image. In practical implementation, after separating the audio data including the speaker's voice from the source video data, the audio data including the voice may be divided into a plurality of audio clips, each corresponding to a face image.

Illustratively, a first face image to an n-th face image and the audio data including the voice may be separated from the pre-acquired source video data. The audio data including the voice may be divided into a first audio clip o an n-th audio clip. The n may be an integer greater than 1. For an integer i no less than 1 and no greater than the n, the time period of the i-th audio clip may include the time point when the i-th face image appears.

In S102, face shape information and head posture information are extracted from the each face image. Facial expression information is acquired according to the audio clip corresponding to the each face image. Face key point information of the each face image is acquired according to the facial expression information, the face shape information, and the head posture information.

In a practical application, the face images and the audio clip corresponding to the each face image may be input to a first neural network trained in advance. The following steps may be implemented based on the first neural network. The face shape information and the head posture information may be extracted from the each face image. The facial expression information may be acquired according to the audio clip corresponding to the each face image. The face key point information of the each face image may be acquired according to the facial expression information, the face shape information, and the head posture information.

In embodiments of the present disclosure, the face shape information may represent information on the shape and the size of a part of a face. For example, the face shape information may represent a mouth shape, a lip thickness, an eye size, etc. The face shape information is related to a personal identity. Understandably, the face shape information related to the personal identity may be acquired according to an image containing the face. In a practical application, the face shape information may be a parameter related to the shape of the face.

The head posture information may represent information such as the orientation of the face. For example, a head posture may represent head-up, head-down, facing left, facing right, etc. Understandably, the head posture information may be acquired according to an image containing the face. In a practical application, the head gesture information may be a parameter related to a head gesture.

Illustratively, the facial expression information may represent an expression such as joy, grief, pain, etc. Here, the facial expression information is illustrated with examples only. In embodiments of the present disclosure, the facial expression information is not limited to the expressions described above. The facial expression information is related to a facial movement. Therefore, when a person speaks, facial movement information may be acquired according to audio information including the voice, thereby acquiring the facial expression information. In a practical application, the facial expression information may be a parameter related to a facial expression.

For an implementation in which face shape information and head posture information are extracted from each face image, illustratively, the each face image may be input to a 3D Face Morphable Model (3DMM), and face shape information and head posture information of the each face image may be extracted using the 3DMM.

For an implementation in which the facial expression information is acquired according to the audio clip corresponding to the each face image, illustratively, an audio feature of the audio clip may be extracted. Then, the facial expression information may be acquired according to the audio feature of the audio clip.

In embodiments of the present disclosure, a type of an audio feature of an audio clip is not limited. For example, an audio feature of an audio clip may be a Mel Frequency Cepstrum Coefficient (MFCC) or another frequency domain feature.

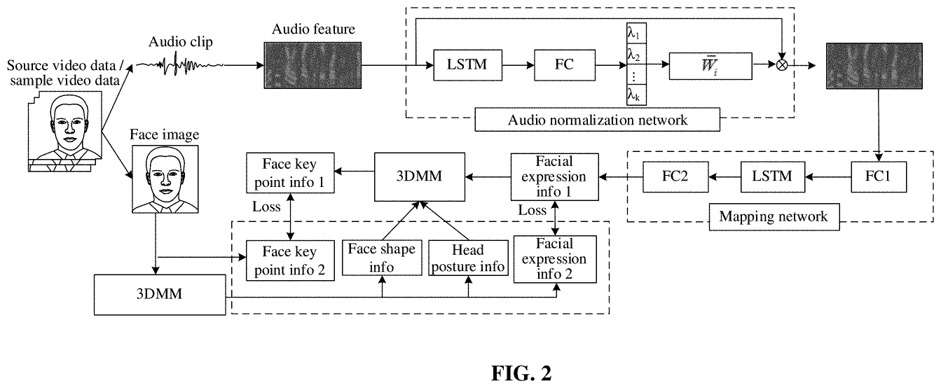

Below, FIG. 2 illustrates architecture of a first neural network according to embodiments of the present disclosure. As shown in FIG. 2, in a stage of applying the first neural network, face images and audio data including the voice may be separated from the source video data. The audio data including the voice may be divided into a plurality of audio clips, each corresponding to a face image. Each face image may be input to the 3DMM. The face shape information and the head posture information of the each face image may be extracted using the 3DMM. An audio feature of the audio clip corresponding to the each face image may be extracted. Then, the extracted audio feature may be processed through an audio normalization network, removing timbre information of the audio feature. The audio feature with the timbre information removed may be processed through a mapping network, acquiring facial expression information. In FIG. 2, the facial expression information acquired by the processing via the mapping network may be denoted as facial expression information 1. The facial expression information 1, the face shape information, and the head posture information may be processed using the 3DMM, acquiring face key point information. In FIG. 2, the face key point information acquired using the 3DMM may be denoted as face key point information 1.

For an implementation of acquiring facial expression information according to an audio clip corresponding to a face image, illustratively, an audio feature of the audio clip may be extracted. Timbre information of the audio feature may be removed. The facial expression information may be acquired according to the audio feature with the timbre information removed.

In embodiments of the present disclosure, the timbre information may be information related to the identity of the speaker. A facial expression may be independent of the identity of the speaker. Therefore, after the timbre information related to the identity of the speaker has been removed from the audio feature, more accurate facial expression information may be acquired according to the audio feature with the timbre information removed.

Illustratively, for an implementation of removing the timbre information of the audio feature, the audio feature may be normalized to remove the timbre information of the audio feature. In a specific example, the audio features may be normalized based on a feature-based Maximum Likelihood Linear Regression (fMLLR) method of a feature space to remove the timbre information of the audio feature.

In embodiments of the present disclosure, the audio features may be normalized based on the fMLLR method as illustrated using a formula (1).

x′=Wᵢx+bᵢ=W̅ᵢx̅ (1)

The x denotes an audio feature yet to be normalized. The x′ denotes a normalized audio feature with the timbre information removed. The Wᵢ and the bᵢ denote different specific normalization parameters of the speaker. The Wᵢ denotes a weight. The bᵢ denotes an offset. W̅ᵢ=(Wᵢ, bᵢ). x̅=(x,1).

When an audio feature in an audio clip represents audio features of the voice of multiple speakers, the W̅ᵢ may be decomposed into a weighted sum of a number of sub-matrices and an identity matrix according to a formula (2).

$${\overline{W}}_{i} = I + {\sum }_{i = 1}^{k} {λ}_{i} {\overline{W}}^{i} \qquad ( 2 )$$

The I denotes the identity matrix. The W̅ⁱ denotes an i-th sub-matrix. The λᵢ denotes a weight coefficient corresponding to the i-th sub-matrix. The k denotes the number of speakers. The k may be a preset parameter.

In a practical application, the first neural network may include an audio normalization network in which an audio feature may be normalized based on the fMLLR method.

Illustratively, the audio normalization network may be a shallow neural network. In a specific example, referring to FIG. 2, the audio normalization network may include at least a Long Short-Term Memory (LSTM) layer and a Fully Connected (FC) layer. After an audio feature has been input to the LSTM layer and sequentially processed by the LSTM layer and the FC layer, the offset bᵢ, the sub-matrices, and the weight coefficient corresponding to each sub-matrix may be acquired. Further, the normalized audio feature x′ with the timbre information removed may be acquired according to a formulas (1) and (2).

For implementation of acquiring the facial expression information according to the audio feature with the timbre information removed, illustratively, as shown in FIG. 2, FC1 and FC2 may denote two FC layers, and LSTM may denote a multi-layer LSTM layer. It may be seen that the facial expression information may be acquired by sequentially processing, via the FC1, the multi-layer LSTM layer, and the FC2, the audio feature with the timbre information removed.

As shown in FIG. 2, during training of the first neural network, sample face images and audio data including a voice may be separated from the sample video data. The audio data including the voice may be divided into a plurality of sample audio clips, each corresponding to a sample face image. For each sample face image and a sample audio clip corresponding to the each sample face image, a data processing process of a stage of applying the first neural network may be implemented, so that predicted facial expression information and predicted face key point information may be acquired. Here, the predicted facial expression information may be denoted as facial expression information 1, and the predicted face key point information may be denoted as face key point information 1. Meanwhile, during training of the first neural network, each sample face image may be input to the 3DMM, and facial expression information of the each sample face image may be extracted using the 3DMM. Face key point information may be acquired directly according to the each sample face image. In FIG. 2, facial expression information of each sample face image extracted using the 3DMM (i.e., a facial expression marker result) may be denoted as facial expression information 2. Face key point information acquired directly according to each sample face image (i.e., a face key point marker result) may be denoted as face key point information 2. During training of the first neural network, a loss of the first neural network may be computed according to a difference between the face key point information 1 and the face key point information 2, and/or a difference between the facial expression information 1 and the facial expression information 2. The first neural network may be trained according to the loss of the first neural network, until the first neural network that has been trained is acquired.

The face key point information of the each face image may be acquired according to the facial expression information, the face shape information, and the head posture information as follows. Illustratively, face point cloud data may be acquired according to the facial expression information and the face shape information. The face point cloud data may be projected to a two-dimensional image according to the head posture information to obtain the face key point information of the each face image.

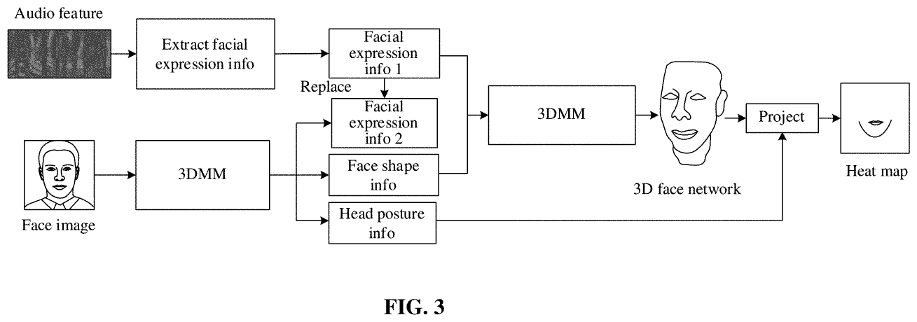

FIG. 3 is an illustrative diagram of acquiring face key point information of each face image according to embodiments of the present disclosure. In FIG. 3, meanings of facial expression information 1, facial expression information 2, face shape information, and head posture information are consistent with those in FIG. 2. It may be seen that, referring to content described above, facial expression information 1, face shape information, and head posture information may have to be acquired at both stages of training and applying the first neural network. The facial expression information 2 may be acquired at only the stage of training the first neural network, and does not have to be acquired at the stage of applying the first neural network.

Referring to FIG. 3, in actual implementation, after a face image has been input to the 3DMM, face shape information, head posture information, and facial expression information 2 of each face image may be extracted using the 3DMM. After facial expression information 1 has been acquired according to the audio feature, facial expression information 2 may be replaced by facial expression information 1. Facial expression information 1 and face shape information may be input to the 3DMM. Facial expression information 1 and face shape information may be processed based on the 3DMM, acquiring face point cloud data. The face point cloud data acquired here may represent a set of point cloud data. In some embodiments of the present disclosure, referring to FIG. 3, the face point cloud data may be presented in form of a three-dimensional 3D face mesh.

In embodiments of the present disclosure, the facial expression information 1 is denoted as ê, the facial expression information 2 is denoted as e, the head posture information is denoted as p, and the face shape information is denoted as s. In this case, the face key point information of each face image may be acquired as illustrated by a formula (3).

M=mesh(s,ê),\hat{l}=project(M,p) (3)

The mesh (s,ê) represents a function for processing the facial expression information 1 and the face shape information, acquiring the 3D face mesh. The M represents the 3D face mesh. The project (M,p) represents a function for projecting the 3D face mesh to a two-dimensional image according to the head posture information. The \hat{l} represents face key point information of a face image.

In embodiments of the present disclosure, a face key point is a label for locating a contour and a feature of a face in an image, and is mainly configured to determine a key location on the face, such as a face contour, eyebrows, eyes, lips, etc. Here, the face key point information of the each face image may include at least the face key point information of a speech-related part. Illustratively, the speech-related part may include at least the mouth and the chin.

It may be seen that since the face key point information is acquired by considering the head posture information, the face key point information may represent the head posture information. Therefore, a face image acquired subsequently according to the face key point information may reflect the head posture information.

Further, with reference to FIG. 3, the face key point information of the each face image may be coded into a heat map, so that the face key point information of the each face image may be represented by the heat map.

In S103, the face images acquired are inpainted according to the face key point information of the each face image, acquiring each generated image.

In an actual application, the face key point information of the each face image and the face images acquired may be input to a second neural network trained in advance. The face images acquired may be inpainted based on the second neural network according to the face key point information of the each face image, to obtain the each generated image.

In an example, a face image with no masked portion may be acquired in advance for each face image. For example, for a first face image to an n-th face image separated from the pre-acquired source video data, a first face image to an n-th face image with no masked portion may be acquired in advance. For an integer i no less than 1 and no greater than the n, the i-th face image separated from the pre-acquired source video data may correspond to the i-th face image with no masked portion acquired in advance. In specific implementation, a face key point portion of a face images with no masked portion acquired may be covered according to the face key point information of the each face image, acquiring each generated image.

In another example, a face image with a masked portion may be acquired in advance for each face image. For example, for a first face image to an n-th face image separated from the pre-acquired source video data, a first face image to an n-th face image each with a masked portion may be acquired in advance. For an integer i no less than 1 and no greater than the n, the i-th face image separated from the pre-acquired source video data may correspond to the i-th face image with the masked portion acquired in advance. A face image with a masked portion may represent a face image in which the speech-related part is masked.

In embodiments of the present disclosure, the face key point information of the each face image and the face images with masked portions acquired may be input to the second neural network trained in advance as follows. Exemplarily, when the first face image to the n-th face image have been separated from the pre-acquired source video data, for an integer i no less than 1 and no greater than the n, the face key point information of the i-th face image and the i-th face image with the masked portion may be input to the pre-trained second neural network.

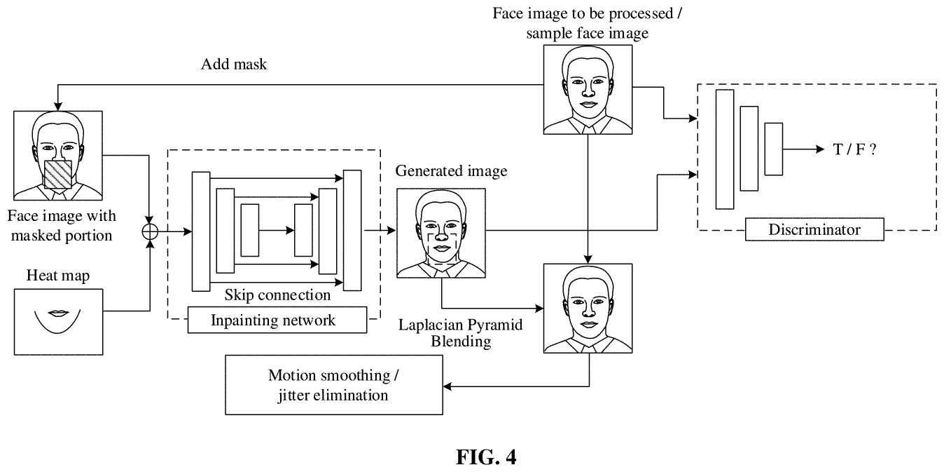

Architecture of a second neural network according to embodiments of the present disclosure is illustrated below via FIG. 4. As shown in FIG. 4, in the stage of applying the second neural network, at least one to-be-processed face image with no masked portion may be acquired in advance. Then, a mask may be added to each to-be-processed face image with no masked portion, acquiring a face image with a masked portion. Illustratively, a face image to be processed may be a real face image, an animated face image, or a face image of another type.

A masked portion of a face image with the masked portion acquired in advance may be inpainted according to face key point information of each face image as follows. Illustratively, the second neural network may include an inpainting network for performing image synthesis. In the stage of applying the second neural network, face key point information of the each face image and a previously acquired face image with a masked portion may be input to the inpainting network. In the inpainting network, the masked portion of the previously acquired face image with the masked portion may be inpainted according to face key point information of the each face image, acquiring each generated image.

In a practical application, referring to FIG. 4, when face key point information of each face image is coded into a heat map, the heat map and a previously acquired face image with a masked portion may be input to the inpainting network, and the previously acquired face image with the masked portion may be inpainted using the inpainting network according to the heat map, acquiring a generated image. For example, the inpainting network may be a neural network with a skip connection.

In embodiments of the present disclosure, an image may be inpainted using the inpainting network as illustrated via a formula (4).

\hat{F}=Ψ(N,H) (4)

The N denotes a face images acquired with a masked portion. The H denotes a heat map representing face key point information. The Ψ(N,H) denotes a function for inpainting the heat map and the face images acquired with the masked portion. The \hat{F} denotes a generated image.

Referring to FIG. 4, during training of the second neural network, sample face images with no masked portion may be acquired. The sample face images may be processed according to the mode of processing to-be-processed face images by the second neural network, acquiring generated images corresponding respectively to the sample face images.

Further, referring to FIG. 4, during training of the second neural network, the sample face images and the generated images may have to be input to a discriminator. The discriminator may be configured to determine a probability that a sample face image is a real image, and determine a probability that a generated image is a real image. A first discrimination result and a second discrimination result may be acquired by the discriminator. The first discrimination result may represent a probability that the sample face image is a real image. The second discrimination result may represent a probability that the generated image is real. The second neural network may then be trained according to the loss of the second neural network, until the trained second neural network is acquired. Here, the loss of the second neural network may include an adversarial loss. The adversarial loss may be acquired according to the first discrimination result and the second discrimination result.

In S104, a target video is generated according to the each generated image.

S104 may be implemented as follows. In an example, a regional image of the each generated image other than a face key point may be adjusted according to the face images acquired to obtain an adjusted generated image. The target video may be formed using the adjusted generated image. In this way, in embodiments of the present disclosure, the region image of an adjusted generated image other than the face key point may be made to better match a to-be-processed face image acquired, better matching the adjusted generated image to a practical need.

In a practical application, in the second neural network, a regional image of the each generated image other than a face key point may be adjusted according to the face images acquired to obtain an adjusted generated image.

Illustratively, referring to FIG. 4, in the stage of applying the second neural network, a pre-acquired to-be-processed face image with no masked portion and a generated image may be blended using Laplacian Pyramid Blending, acquiring an adjusted generated image.

Of course, in another example, the target video may be formed directly using each generated image, thus facilitating implementation.

In a practical application, S101 to S104 may be implemented using a processor in electronic equipment. The processor may be at least one of an Application Specific Integrated Circuit (ASIC), a Digital Signal Processor (DSP), a Digital Signal Processing Device (DSPD), a Programmable Logic Device (PLD), an FPGA, a Central Processing Unit (CPU), a controller, a microcontroller, a microprocessor, etc.

It may be seen that in embodiments of the present disclosure, since the face key point information is acquired by considering the head posture information, each generated image acquired according to the face key point information may reflect the head posture information, and thus the target video may reflect the head posture information. The head posture information is acquired according to each face image, and each face image may be acquired according to a practical need related to a head posture. Therefore, with embodiments of the present disclosure, a target video may be generated corresponding to each face image that meets the practical need related to the head posture, so that the generated target video meets the practical need related to the head posture.

Further, referring to FIG. 4, in the stage of applying the second neural network, motion smoothing processing may be performed on a face key point of a speech-related part of an image in the target video, and/or jitter elimination may be performed on the image in the target video. The speech-related part may include at least a mouth and a chin.

It may be appreciated that by performing motion smoothing processing on a face key point of a speech-related part of an image in the target video, jitter of the speech-related part in the target video may be reduced, improving an effect of displaying the target video. By performing jitter elimination on the image in the target video, image flickering in the target video may be reduced, improving an effect of displaying the target video.

For example, motion smoothing processing may be performed on the face key point of the speech-related part of the image in the target video as follows. For a t greater than or equal to 2, when a distance between a center of a speech-related part of a t-th image of the target video and a center of a speech-related part of a (t−1)-th image of the target video is less than or equal to a set distance threshold, motion smoothed face key point information of the speech-related part of the t-th image of the target video may be acquired according to face key point information of the speech-related part of the t-th image of the target video and face key point information of the speech-related part of the (t−1)-th image of the target video.

It should be noted that for the t greater than or equal to 2, when the distance between the center of the speech-related part of the t-th image of the target video and the center of the speech-related part of the (t−1)-th image of the target video is greater than the set distance threshold, the face key point information of the speech-related part of the t-th image of the target video may be taken directly as the motion smoothed face key point information of the speech-related part of the t-th image of the target video. That is, motion smoothing processing on the face key point information of the speech-related part of the t-th image of the target video is not required.

In a specific example, lₜ₋₁ may represent face key point information of a speech-related part of the (t−1)-th image of the target video. The lₜ may represent face key point information of a speech-related part of the t-th image of the target video. The dₜₕ may represent the set distance threshold. The s may represent a set intensity of motion smoothing processing. The l′ₜ may represent motion smoothed face key point information of the speech-related part of the t-th image of the target video. The cₜ₋₁ may represent the center of the speech-related part of the (t−1)-th image of the target video. The cₜ may represent the center of the speech-related part of the t-th image of the target video.

In case ∥cₜ−cₜ₋₁∥₂>dₜₕ, l′ₜ=lₜ.

In case ∥cₜ−cₜ₋₁∥₂≤dₜₕ, l′ₜ=αlₜ₋₁+(1−α)lₜ. α=exp(−s∥cₜ−cₜ₋₁∥₂).

As an example, jitter elimination may be performed on the image in the target video as follows. For a t greater than or equal to 2, jitter elimination may be performed on a t-th image of the target video according to a light flow from a (t−1)-th image of the target video to the t-th image of the target video, the (t−1)-th image of the target video with jitter eliminated, and a distance between a center of a speech-related part of the t-th image of the target video and a center of a speech-related part of the (t−1)-th image of the target video.

In a specific example, jitter elimination may be performed on the t-th image of the target video as illustrated using a formula (5).

$$F ( {O}_{t} ) = \frac{4 {π}^{2} {f}^{2} F ( {P}_{t} ) + {λ}_{t} F ( warp ( {O}_{t - 1} ) )}{4 {π}^{2} {f}^{2} + {λ}_{t}} , {λ}_{t} = exp ( - {d}_{t} ) \qquad ( 5 )$$

The Pₜ may represent the t-th image of the target video without jitter elimination. The Oₜ may represent the t-th image of target video with jitter eliminated. The Oₜ₋₁ may represent the (t−1)-th image of the target video with jitter eliminated. The F( ) may represent a Fourier transform. The f may represent a frame rate of the target video. The dₜ may represent the distance between the centers of the speech-related parts of the t-th image and the (t−1)-th image of the target video. The warp(Oₜ₋₁) may represent an image acquired after applying the light flow from the (t−1)-th image to the t-th image of the target video to the Oₜ₋₁.

The method for generating a video according to embodiments of the present disclosure may be applied in multiple scenes. In an illustrative scene of application, video information including a face image of a customer service person may have to be displayed on a terminal. Each time input information is received or a service is requested, a presentation video of the customer service person is to be played. In this case, face images acquired in advance and an audio clip corresponding to each face image may be processed according to the method for generating a video of embodiments of the present disclosure, acquiring face key point information of the each face image. Then, each face image of the customer service person may be inpainted according to the face key point information of the each face image, acquiring each generated image, thereby synthesizing in the background the presentation video where the customer person speaks.

It should be noted that the foregoing is merely an example of a scene of application of embodiments of the present disclosure, which is not limited hereto.

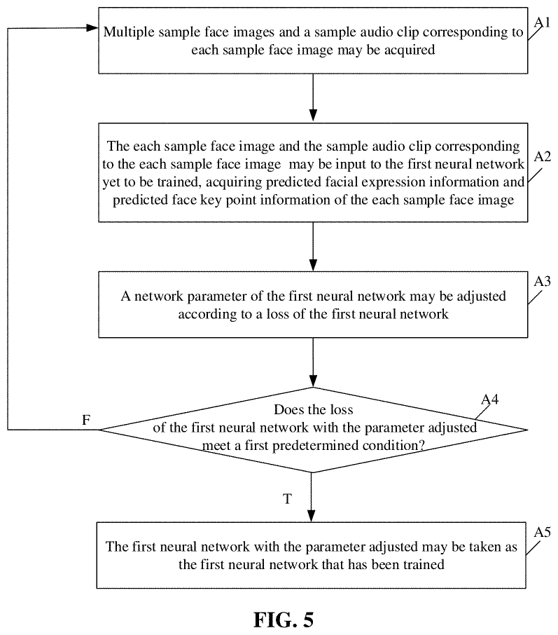

FIG. 5 is a flowchart of a method for training a first neural network according to embodiments of the present disclosure. As shown in FIG. 5, the flow may include steps as follows.

In A1, multiple sample face images and a sample audio clip corresponding to each sample face image of the multiple sample face images may be acquired.

In a practical application, the sample face images and sample audio data including a voice may be separated from sample video data. A sample audio clip corresponding to the each sample face image may be determined. The sample audio clip corresponding to the each sample face image may be a part of the sample audio data.

Here, each image of the sample video data may include a sample face image, and audio data in the sample video data may include the voice of a speaker. In embodiments of the present disclosure, the source and format of the sample video data are not limited.

In embodiments of the present disclosure, the sample face images and the sample audio data including the voice may be separated from the sample video data in a mode same as the face images and the audio data including the voice are separated from the pre-acquired source video data, which is not repeated here.

In A2, the each sample face image and the sample audio clip corresponding to the each sample face image may be input to the first neural network yet to be trained, acquiring predicted facial expression information and predicted face key point information of the each sample face image.

In embodiments of the present disclosure, the implementation of this step has been described in S102, which is not repeated here.

In A3, a network parameter of the first neural network may be adjusted according to a loss of the first neural network.

Here, the loss of the first neural network may include an expression loss and/or a face key point loss. The expression loss may be configured to represent a difference between the predicted facial expression information and a facial expression marker result. The face key point loss may be configured to represent a difference between the predicted face key point information and a face key point marker result.

In actual implementation, the face key point marker result may be extracted from the each sample face image, or each face image may be input to the 3DMM, and the facial expression information extracted using the 3DMM may be taken as the facial expression marker result.

Here, the expression loss and the face key point loss may be computed according to a formula (6).

Lₑₓₚ=∥ê−e∥₁,L_{ldmk}=∥\hat{l}−l∥₁ (6)

The e denotes the facial expression marker result. The ê denotes the predicted facial expression information acquired based on the first neural network. The Lₑₓₚ denotes the expression loss, l denotes the face key point marker result. The \hat{l} denotes the predicted face key point information acquired based on the first neural network. The L_{ldmk} denotes the face key point loss. The ∥·∥₁ denotes a norm 1.

Referring to FIG. 2, the face key point information 2 may represent the face key point marker result, and the facial expression information 2 may represent the facial expression marker result. Thus, the face key point loss may be acquired according to the face key point information 1 and the face key point information 2, and the expression loss may be acquired according to the facial expression information 1 and the facial expression information 2.

In A4, it may be determined whether the loss of the first neural network with the network parameter adjusted meets a first predetermined condition. If it fails to meet the condition, A1 to A4 may be repeated. If the condition is met, A5 may be implemented.

In some embodiments of the present disclosure, the first predetermined condition may be that the expression loss is less than a first set loss, that the face key point loss is less than a second set loss, or that a weighted sum of the expression loss and the face key point loss is less than a third set loss. In embodiments of the present disclosure, the first set loss, the second set loss, and the third set loss may all be preset as needed.

Here, the weighted sum L₁ of the expression loss and the face key point loss may be expressed by a formula (7).

L₁=α₁Lₑₓₚ+α₂L_{ldmk} (7)

Here, the α₁ may represent the weight coefficient of the expression loss, and the α₂ may represent the weight coefficient of the face key point loss. Both α₁ and α₂ may be empirically set as needed.

In A5, the first neural network with the network parameter adjusted may be taken as the trained first neural network.

In a practical application, A1 to A5 may be implemented using a processor in electronic equipment. The processor may be at least one of an Application Specific Integrated Circuit (ASIC), a Digital Signal Processor (DSP), a Digital Signal Processing Device (DSPD), a Programmable Logic Device (PLD), an FPGA, a Central Processing Unit (CPU), a controller, a microcontroller, a microprocessor, etc.

It may be seen that, during training of the first neural network, the predicted face key point information may be acquired by considering the head posture information. The head posture information may be acquired according to a face image in the source video data. The source video data may be acquired according to a practical need related to a head posture. Therefore, the trained first neural network may better generate the face key point information corresponding to the source video data meeting the practical need related to the head posture.

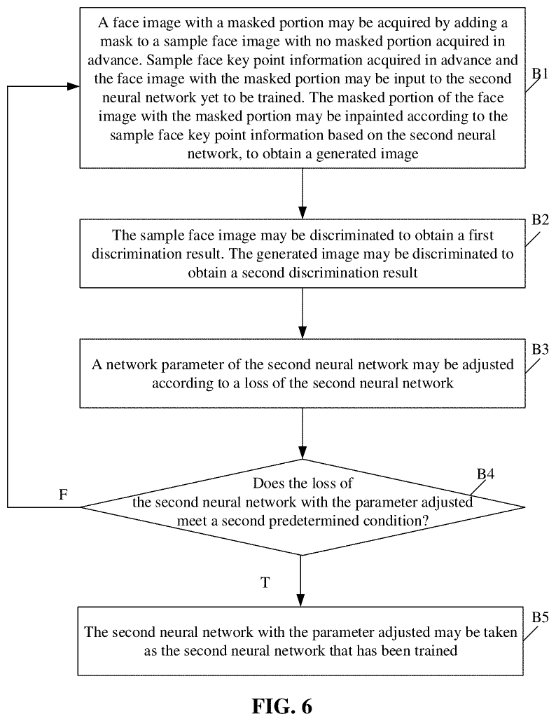

FIG. 6 is a flowchart of a method for training a second neural network according to embodiments of the present disclosure. As shown in FIG. 6, the flow may include steps as follows.

In B1, a face image with a masked portion may be acquired by adding a mask to a sample face image with no masked portion acquired in advance. Sample face key point information acquired in advance and the face image with the masked portion may be input to the second neural network yet to be trained. The masked portion of the face image with the masked portion may be inpainted according to the sample face key point information based on the second neural network, to obtain a generated image.

The implementation of this step has been described in S103, which is not repeated here.

In B2, the sample face image may be discriminated to obtain a first discrimination result. The generated image may be discriminated to obtain a second discrimination result.

In B3, a network parameter of the second neural network may be adjusted according to a loss of the second neural network.

Here, the loss of the second neural network may include an adversarial loss. The adversarial loss may be acquired according to the first discrimination result and the second discrimination result.

Here, the adversarial loss may be computed according to a formula (8).

L_{adv}=(D(\hat{F})−1)²(D(F)−1)²+(D(\hat{F})−0)² (8)

The L_{adv} represents the adversarial loss. The D(\hat{F}) represents the second discrimination result. The F represents a sample face image. The D(F) represents the first discrimination result.

In some embodiments of the present disclosure, the loss of the second neural network further includes at least one of a pixel reconstruction loss, a perceptual loss, an artifact loss, or a gradient penalty loss. The pixel reconstruction loss may be configured to represent a difference between the sample face image and the generated image. The perceptual loss may be configured to represent a sum of differences between the sample face image and the generated image at different scales. The artifact loss may be configured to represent a spike artifact of the generated image. The gradient penalty loss may be configured to limit a gradient for updating the second neural network.

In embodiments of the present disclosure, the pixel reconstruction loss may be computed according to a formula (9).

L_{recon}=∥Ψ(N,H)−F∥₁ (9)

The L_{recon} denotes the pixel reconstruction loss. The ∥·∥₁ denotes taking a norm 1.

In a practical application, a sample face image may be input to a neural network for extracting features at different scales image, to extract features of the sample face image at different scales. A generated image may be input to a neural network for extracting features at different scales, to extract features of the generated image at different scales. Here, a feature of the generated image at an i-th scale may be represented by featᵢ(\hat{F}). A features of the sample face image at the i-th scale may be represented by featᵢ(F). The perceptual loss may be expressed as L_{vgg}.

In an example, the neural network configured to extract image features at different scales is a VGG16 network. The sample face image or the generated image may be input to the VGG16 network, to extract features of the sample face image or the generated image at the first scale to the fourth scale. Here, features acquired using a relu1_2 layer, a relu2_2 layer, a relu3_3 layer, and a relu3_4 layer may be taken as features of the sample face image or the generated image at the first scale to the fourth scale, respectively. In this case, the perceptual loss may be computed according to a formula (10).

$${L}_{vgg} = {\sum }_{i = 1}^{4} {‖ {feat}_{i} ( \hat{F} ) - {feat}_{i} ( F ) ‖}_{1} \qquad ( 10 )$$

In B4, it may be determined whether the loss of the second neural network with the network parameter adjusted meets a second predetermined condition. If it fails to meet the condition, B1 to B4 may be repeated. If the condition is met, B5 may be implemented.

In some embodiments of the present disclosure, the second predetermined condition may be that the adversarial loss is less than a fourth set loss. In embodiments of the present disclosure, the fourth set loss may be preset as needed.

In some embodiments of the present disclosure, the second predetermined condition may also be that a weighted sum of the adversarial loss and at least one loss as follows is less than a fifth set loss: a pixel reconstruction loss, a perceptual loss, an artifact loss, or a gradient penalty loss. In embodiments of the present disclosure, the fifth set loss may be preset as needed.

In a specific example, the weighted sum L₂ of the adversarial loss, the pixel reconstruction loss, the perceptual loss, the artifact loss, and the gradient penalty loss may be described according to a formula (11).

L₂=β₁L_{recon}+β₂L_{adv}+β₃L_{vgg}+β₄Lₜᵥ+β₅L_{gp} (11)

The Lₜᵥ represents the artifact loss. The L_{gp} represents the gradient penalty loss. The β₁ represents the weight coefficient of the pixel reconstruction loss. The β₂ represents the weight coefficient of the adversarial loss. The β₃ represents the weight coefficient of the perceptual loss. The β₄ represents the weight coefficient of the artifact loss. The β₅ represents the weight coefficient of the gradient penalty loss. The β₁, β₂, β₃, β₄ and β₅ may be empirically set as needed.

In B5, the second neural network with the network parameter adjusted may be taken as the trained second neural network.

In a practical application, B1 to B5 may be implemented using a processor in electronic equipment. The processor may be at least one of an Application Specific Integrated Circuit (ASIC), a Digital Signal Processor (DSP), a Digital Signal Processing Device (DSPD), a Programmable Logic Device (PLD), an FPGA, a Central Processing Unit (CPU), a controller, a microcontroller, a microprocessor, etc.

It may be seen that, during training of the second neural network, a parameter of the neural network may be adjusted according to the discrimination result of the discriminator, so that a realistic generated image may be acquired. That is, the trained second neural network may acquire a more realistic generated image.

A person having ordinary skill in the art may understand that in a method of a specific implementation, the order in which the steps are put is not necessarily a strict order in which the steps are implemented, and does not form any limitation to the implementation process. A specific order in which the steps are implemented should be determined according to a function and a possible intrinsic logic thereof.

On the basis of the method for generating a video set forth in the foregoing embodiments, embodiments of the present disclosure propose a device for generating a video.

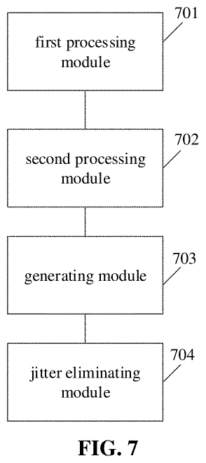

FIG. 7 is an illustrative diagram of a structure of a device for generating a video according to embodiments of the present disclosure. As shown in FIG. 7, the device includes a first processing module 701, a second processing module 702, and a generating module 703.

The first processing module 701 is configured to acquire face images and an audio clip corresponding to each face image of the face images.

The second processing module 702 is configured to extract face shape information and head posture information from the each face image, acquire facial expression information according to the audio clip corresponding to the each face image, and acquire face key point information of the each face image according to the facial expression information, the face shape information, and the head posture information; inpaint, according to the face key point information of the each face image, the face images acquired, acquiring each generated image.

The generating module 703 is configured to generate a target video according to the each generated image.

In some embodiments of the present disclosure, the second processing module 702 is configured to acquire face point cloud data according to the facial expression information and the face shape information; and project the face point cloud data to a two-dimensional image according to the head posture information to obtain the face key point information of the each face image.

In some embodiments of the present disclosure, the second processing module 702 is configured to extract an audio feature of the audio clip; remove timbre information of the audio feature; and acquire the facial expression information according to the audio feature with the timbre information removed.

In some embodiments of the present disclosure, the second processing module 702 is configured to remove the timbre information of the audio feature by normalizing the audio feature.

In some embodiments of the present disclosure, the generating module 703 is configured to adjust, according to a face image acquired, a regional image of the each generated image other than a face key point to obtain an adjusted generated image, and form the target video using the adjusted generated image.

In some embodiments of the present disclosure, referring to FIG. 7, the device further includes a jitter eliminating module 704. The jitter eliminating module 704 is configured to perform motion smoothing processing on a face key point of a speech-related part of an image in the target video, and/or perform jitter elimination on the image in the target video. The speech-related part may include at least a mouth and a chin.

In some embodiments of the present disclosure, the jitter elimination module 704 is configured to, for a t greater than or equal to 2, in response to a distance between a center of a speech-related part of a t-th image of the target video and a center of a speech-related part of a (t−1)-th image of the target video being less than or equal to a set distance threshold, acquire motion smoothed face key point information of the speech-related part of the t-th image of the target video according to face key point information of the speech-related part of the t-th image of the target video and face key point information of the speech-related part of the (t−1)-th image of the target video.

In some embodiments of the present disclosure, the jitter eliminating module 704 is configured to, for a t greater than or equal to 2, perform jitter elimination on a t-th image of the target video according to a light flow from a (t−1)-th image of the target video to the t-th image of the target video, the (t−1)-th image of the target video with jitter eliminated, and a distance between a center of a speech-related part of the t-th image of the target video and a center of a speech-related part of the (t−1)-th image of the target video.

In some embodiments of the present disclosure, the first processing module 701 is configured to acquire source video data, separate the face images and audio data including a voice from the source video data, and determine the audio clip corresponding to the each face image. The audio clip corresponding to the each face image may be part of the audio data.

In some embodiments of the present disclosure, the second processing module 702 is configured to input the face images and the audio clip corresponding to the each face image to a first neural network trained in advance; and extract the face shape information and the head posture information from the each face image, acquire the facial expression information according to the audio clip corresponding to the each face image, and acquire the face key point information of the each face image according to the facial expression information, the face shape information, and the head posture information based on the first neural network.

In some embodiments of the present disclosure, the first neural network is trained as follows.

Multiple sample face images and a sample audio clip corresponding to each sample face image of the multiple sample face images may be acquired.

The each sample face image and the sample audio clip corresponding to the each sample face image may be input to the first neural network yet to be trained, acquiring predicted facial expression information and predicted face key point information of the each sample face image.

A network parameter of the first neural network may be adjusted according to a loss of the first neural network. The loss of the first neural network may include an expression loss and/or a face key point loss. The expression loss may be configured to represent a difference between the predicted facial expression information and a facial expression marker result. The face key point loss may be configured to represent a difference between the predicted face key point information and a face key point marker result.

Above-mentioned steps may be repeated until the loss of the first neural network meets a first predetermined condition, acquiring the first neural network that has been trained.

In some embodiments of the present disclosure, the second processing module 702 is configured to input the face key point information of the each face image and the face images acquired to a second neural network trained in advance, and inpaint, based on the second neural network according to the face key point information of the each face image, the face images acquired, to obtain the each generated image.

In some embodiments of the present disclosure, the second neural network is trained as follows.

A face image with a masked portion may be acquired by adding a mask to a sample face image with no masked portion acquired in advance. Sample face key point information acquired in advance and the face image with the masked portion may be input to the second neural network yet to be trained. The masked portion of the face image with the masked portion may be inpainted according to the sample face key point information based on the second neural network, to obtain a generated image.

The sample face image may be discriminated to obtain a first discrimination result. The generated image may be discriminated to obtain a second discrimination result.

A network parameter of the second neural network may be adjusted according to a loss of the second neural network. The loss of the second neural network may include an adversarial loss. The adversarial loss may be acquired according to the first discrimination result and the second discrimination result.

Above-mentioned steps may be repeated until the loss of the second neural network meets a second predetermined condition, acquiring the second neural network that has been trained.

In some embodiments of the present disclosure, the loss of the second neural network further includes at least one of a pixel reconstruction loss, a perceptual loss, an artifact loss, or a gradient penalty loss. The pixel reconstruction loss may be configured to represent a difference between the sample face image and the generated image. The perceptual loss may be configured to represent a sum of differences between the sample face image and the generated image at different scales. The artifact loss may be configured to represent a spike artifact of the generated image. The gradient penalty loss may be configured to limit a gradient for updating the second neural network.

In a practical application, the first processing module 701, the second processing module 702, the generating module 703, and the jitter eliminating module 704 may all be implemented using a processor in electronic equipment. The processor may be at least one of an Application Specific Integrated Circuit (ASIC), a Digital Signal Processor (DSP), a Digital Signal Processing Device (DSPD), a Programmable Logic Device (PLD), an FPGA, a Central Processing Unit (CPU), a controller, a microcontroller, a microprocessor, etc.

In addition, various functional modules in the embodiments may be integrated in one processing unit, or exist as separate physical units respectively. Alternatively, two or more such units may be integrated in one unit. The integrated unit may be implemented in form of hardware or software functional unit(s).

When implemented in form of a software functional module and sold or used as an independent product, an integrated unit herein may be stored in a computer-readable storage medium. Based on such an understanding, the essential part of the technical solution of the embodiments or a part contributing to prior art or all or part of the technical solution may appear in form of a software product, which software product is stored in storage media, and includes a number of instructions for allowing computer equipment (such as a personal computer, a server, network equipment, and/or the like) or a processor to execute all or part of the steps of the methods of the embodiments. The storage media include various media that can store program codes, such as a U disk, a mobile hard disk, Read Only Memory (ROM), Random Access Memory (RAM), a magnetic disk, a CD, and/or the like.

Specifically, the computer program instructions corresponding to a method for generating a video in the embodiments may be stored on a storage medium such as a CD, a hard disk, a USB flash disk. When read by electronic equipment or executed, computer program instructions in the storage medium corresponding to a method for generating a video implement any one method for generating a video of the foregoing embodiments.

Correspondingly, embodiments of the present disclosure also propose a computer program, including a computer-readable code which, when run in electronic equipment, allow a processor in the electronic equipment to implement any method for generating a video herein.

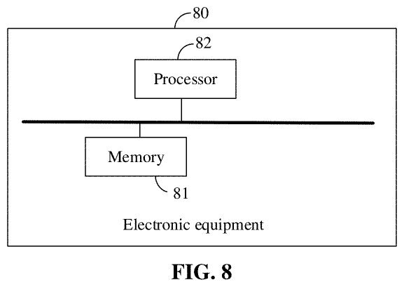

Based on the technical concept same as that of the foregoing embodiments, FIG. 8 illustrates electronic equipment 80 according to embodiments of the present disclosure. The electronic equipment may include a memory 81 and a processor 82.

The memory 81 is configured to store a computer program and data.

The processor 82 is configured to execute the computer program stored in the memory to implement any one method for generating a videos of the foregoing embodiments.

In a practical application, the memory 81 may be a volatile memory such as RAM; or non-volatile memory such as ROM, flash memory, a Hard Disk Drive (HDD), or a Solid-State Drive (SSD); or a combination of the foregoing types of memories, and provide instructions and data to the processor 82.

The processor 502 may be at least one of an ASIC, a DSP, a DSPD, a PLD, a FPGA, a CPU, a controller, a microcontroller, and a microprocessor. It is understandable that, for different equipment, the electronic device configured to implement above-mentioned-mentioned processor functions may also be the other, which is not specifically limited in embodiments of the present disclosure.

In some embodiments, a function or a module of a device provided in embodiments of the present disclosure may be configured to implement a method described in a method embodiment herein. Refer to description of a method embodiment herein for specific implementation of the device, which is not repeated here for brevity.

The above description of the various embodiments tends to emphasize differences in the various embodiments. Refer to one another for identical or similar parts among the embodiments, which are not repeated for conciseness.

Methods disclosed in method embodiments of the present disclosure may be combined with each other as needed, acquiring a new method embodiment, as long as no conflict results from the combination.

Features disclosed in product embodiments of the present disclosure may be combined with each other as needed, acquiring a new product embodiment, as long as no conflict results from the combination.

Features disclosed in method or device embodiments of the present disclosure may be combined with each other as needed, acquiring a new method or device embodiment, as long as no conflict results from the combination.

Through the description of above-mentioned embodiments, a person having ordinary skill in the art may clearly understand that a method of above-mentioned embodiments may be implemented by hardware, or often better, by software plus a necessary general hardware platform. Based on this understanding, the essential part or the part contributing to prior art of a technical solution of the present disclosure may be embodied in form of a software product. The computer software product is stored in a storage medium (such as ROM/RAM, a magnetic disk, and a CD) and includes a number of instructions that allow terminal (which may be a mobile phone, a computer, a server, an air conditioner, or a network device, etc.) to execute a method described in the various embodiments of the present disclosure.

Embodiments of the present disclosure are described above with reference to the drawings. However, the present disclosure is not limited to above-mentioned-mentioned specific implementations. The above-mentioned specific implementations are only illustrative but not restrictive. Inspired by the present disclosure, a person having ordinary skill in the art may further implement many forms without departing from the purpose of the present disclosure and the scope of the claims. These forms are all covered by protection of the present disclosure.

### INDUSTRIAL APPLICABILITY

Embodiments of the present disclosure provide a method and device for generating a video, electronic equipment, a computer storage medium, and a computer program. The method is as follows. Face shape information and head posture information are extracted from each face image. Facial expression information is acquired according to an audio clip corresponding to the each face image. Face key point information of the each face image is acquired according to the facial expression information, the face shape information, and the head posture information. Face images acquired are inpainted according to the face key point information, acquiring each generated image. A target video is generated according to the each generated image. In embodiments of the present disclosure, since the face key point information is acquired by considering the head posture information, the target video may reflect the head posture information. The head posture information is acquired according to each face image. Therefore, with embodiments of the present disclosure, the target video meets the practical need related to the head posture.

What is claimed is:

1. A method for generating a video, comprising:
acquiring face images and an audio clip corresponding to each face image of the face images;
extracting face shape information and head posture information from the each face image, acquiring facial expression information according to the audio clip corresponding to the each face image, and acquiring face key point information of the each face image according to the facial expression information, the face shape information, and the head posture information;
inpainting, according to the face key point information of the each face image, the face images acquired, acquiring each generated image; and
generating a target video according to the each generated image.

2. The method of claim 1, wherein acquiring the face key point information of the each face image according to the facial expression information, the face shape information, and the head posture information comprises:
acquiring face point cloud data according to the facial expression information and the face shape information; and projecting the face point cloud data to a two-dimensional image according to the head posture information to obtain the face key point information of the each face image.

3. The method of claim 1, wherein acquiring the facial expression information according to the audio clip corresponding to the each face image comprises:
extracting an audio feature of the audio clip; removing timbre information of the audio feature; and acquiring the facial expression information according to the audio feature with the timbre information removed.

4. The method of claim 3, wherein removing the timbre information of the audio feature comprises:
removing the timbre information of the audio feature by normalizing the audio feature.

5. The method of claim 1, wherein generating the target video according to the each generated image comprises:
adjusting, according to the face images acquired, a regional image of the each generated image other than a face key point to obtain an adjusted generated image, and forming the target video using the adjusted generated image.

6. The method of claim 1, further comprising:
performing motion smoothing processing on a face key point of a speech-related part of an image in the target video, and/or performing jitter elimination on the image in the target video, wherein the speech-related part comprises at least a mouth and a chin.

7. The method of claim 6, wherein performing motion smoothing processing on the face key point of the speech-related part of the image in the target video comprises:
for a t greater than or equal to 2, in response to a distance between a center of a speech-related part of a t-th image of the target video and a center of a speech-related part of a (t−1)-th image of the target video being less than or equal to a set distance threshold, acquiring motion smoothed face key point information of the speech-related part of the t-th image of the target video according to face key point information of the speech-related part of the t-th image of the target video and face key point information of the speech-related part of the (t−1)-th image of the target video.

8. The method of claim 6, wherein performing jitter elimination on the image in the target video comprises:
for a t greater than or equal to 2, performing jitter elimination on a t-th image of the target video according to a light flow from a (t−1)-th image of the target video to the t-th image of the target video, the (t−1)-th image of the target video with jitter eliminated, and a distance between a center of a speech-related part of the t-th image of the target video and a center of a speech-related part of the (t−1)-th image of the target video.

9. The method of claim 1, wherein acquiring the face images and the audio clip corresponding to the each face image of the face images comprises:
acquiring source video data, separating the face images and audio data comprising a voice from the source video data, and determining the audio clip corresponding to the each face image, the audio clip corresponding to the each face image being part of the audio data.

10. The method of claim 1, wherein extracting the face shape information and the head posture information from the each face image, acquiring the facial expression information according to the audio clip corresponding to the each face image, and acquiring the face key point information of the each face image according to the facial expression information, the face shape information, and the head posture information comprises:
inputting the face images and the audio clip corresponding to the each face image to a first neural network trained in advance; and extracting the face shape information and the head posture information from the each face image, acquiring the facial expression information according to the audio clip corresponding to the each face image, and acquiring the face key point information of the each face image according to the facial expression information, the face shape information, and the head posture information based on the first neural network.

11. The method of claim 10, wherein the first neural network is trained by:
acquiring multiple sample face images and a sample audio clip corresponding to each sample face image of the multiple sample face images;
inputting the each sample face image and the sample audio clip corresponding to the each sample face image to the first neural network yet to be trained, acquiring predicted facial expression information and predicted face key point information of the each sample face image;
adjusting a network parameter of the first neural network according to a loss of the first neural network, the loss of the first neural network comprising an expression loss and/or a face key point loss, the expression loss being configured to represent a difference between the predicted facial expression information and a facial expression marker result, the face key point loss being configured to represent a difference between the predicted face key point information and a face key point marker result; and
repeating above-mentioned steps until the loss of the first neural network meets a first predetermined condition, acquiring the first neural network that has been trained.

12. The method of claim 1, wherein inpainting, according to the face key point information of the each face image, the face images acquired, acquiring the each generated image comprises:
inputting the face key point information of the each face image and the face images acquired to a second neural network trained in advance, and inpainting, based on the second neural network according to the face key point information of the each face image, the face images acquired, to obtain the each generated image.

13. The method of claim 12, wherein the second neural network is trained by:
acquiring a face image with a masked portion by adding a mask to a sample face image with no masked portion acquired in advance, inputting sample face key point information acquired in advance and the face image with the masked portion to the second neural network yet to be trained, and inpainting, according to the sample face key point information based on the second neural network, the masked portion of the face image with the masked portion, to obtain a generated image;
discriminating the sample face image to obtain a first discrimination result, and discriminating the generated image to obtain a second discrimination result;
adjusting a network parameter of the second neural network according to a loss of the second neural network, the loss of the second neural network comprising an adversarial loss, the adversarial loss being acquired according to the first discrimination result and the second discrimination result; and
repeating above-mentioned steps until the loss of the second neural network meets a second predetermined condition, acquiring the second neural network that has been trained.

14. The method of claim 13, wherein the loss of the second neural network further comprises at least one of a pixel reconstruction loss, a perceptual loss, an artifact loss, or a gradient penalty loss, the pixel reconstruction loss being configured to represent a difference between the sample face image and the generated image, the perceptual loss being configured to represent a sum of differences between the sample face image and the generated image at different scales, the artifact loss being configured to represent a spike artifact of the generated image, the gradient penalty loss being configured to limit a gradient for updating the second neural network.

15. Electronic equipment, comprising a processor and a memory configured to store a computer program executable on the processor,
wherein the processor is configured to implement:
acquiring face images and an audio clip corresponding to each face image of the face images;
extracting face shape information and head posture information from the each face image, acquiring facial expression information according to the audio clip corresponding to the each face image, and acquiring face key point information of the each face image according to the facial expression information, the face shape information, and the head posture information;
inpainting, according to the face key point information of the each face image, the face images acquired, acquiring each generated image; and
generating a target video according to the each generated image.

16. The electronic equipment of claim 15, wherein the processor is configured to acquire the face key point information of the each face image according to the facial expression information, the face shape information, and the head posture information by:
acquiring face point cloud data according to the facial expression information and the face shape information; and projecting the face point cloud data to a two-dimensional image according to the head posture information to obtain the face key point information of the each face image.

17. The electronic equipment of claim 15, wherein the processor is configured to acquire the facial expression information according to the audio clip corresponding to the each face image by:
extracting an audio feature of the audio clip; removing timbre information of the audio feature; and acquiring the facial expression information according to the audio feature with the timbre information removed.

18. The electronic equipment of claim 15, wherein the processor is configured to generate the target video according to the each generated image by:
adjusting, according to the face images acquired, a regional image of the each generated image other than a face key point to obtain an adjusted generated image, and forming the target video using the adjusted generated image.

19. The electronic equipment of claim 15, wherein the processor is further configured to implement:
performing motion smoothing processing on a face key point of a speech-related part of an image in the target video, and/or performing jitter elimination on the image in the target video, wherein the speech-related part comprises at least a mouth and a chin.

20. A non-transitory computer-readable storage medium, having stored thereon a computer program which, when executed by a processor, implements:
acquiring face images and an audio clip corresponding to each face image of the face images;
extracting face shape information and head posture information from the each face image, acquiring facial expression information according to the audio clip corresponding to the each face image, and acquiring face key point information of the each face image according to the facial expression information, the face shape information, and the head posture information;
inpainting, according to the face key point information of the each face image, the face images acquired, acquiring each generated image; and
generating a target video according to the each generated image.
